(19) United States
(12) Patent Application Publication
(10) Pub. No.: US 2014/0201229 A1
(43) Pub. Date: Jul. 17, 2014

(54) PROVIDING DISPLAY SUGGESTIONS

(71) Applicant: Google Inc., Mountain View, CA (US)

(72) Inventors: Ulas Kirazci, Mountain View, CA (US); Scott Banachowski, Mountain View, CA (US)

(73) Assignee: Google Inc., Mountain View, CA (US)

(21) Appl. No.: 13/970,072

(22) Filed: Aug. 19, 2013

Related U.S. Application Data
(60) Provisional application No. 61/753,128, filed on Jan. 16, 2013.

(51) Int. Cl. G06F 17/30

(52) U.S. Cl. CPC G06F 17/3097
USPC 707/767

(57) ABSTRACT

Methods, systems, and apparatus, including computer programs encoded on a computer storage medium, for providing display suggestions. In one aspect, a method includes accessing a resource that includes multiple terms, obtaining one or more prefixes that are derived from the multiple terms and, for each prefix, one or more actual suggestions, wherein each actual suggestion is a term from the resource that includes the prefix, obtaining one or more display suggestions, wherein each display suggestion includes two or more successive terms from the resource that are identified as related, and outputting, in response to receiving a user input of a particular prefix, a representation of a particular display suggestion that includes a term that is an actual suggestion for the particular prefix.

### CROSS-REFERENCE TO RELATED APPLICATION

This application claims the benefit of U.S. Provisional Application Ser. No. 61/753,128 filed on Jan. 16, 2013, which is incorporated by reference.

### BACKGROUND

The present specification relates to providing display suggestions for term prefixes.

Search utilities may include predictive capabilities for presenting users with query suggestions, based on characters entered in a search box. As a user enters a search term, a search utility can identify one or more possible completions for the partially entered search term, and can provide the possible completions to the user as suggestions. If the user selects one of the suggestions (i.e., one or more completed terms), the terms can be can be provided to a search engine, and associated search results can be returned to the user. Some e-mail search utilities may suggest the name of a contact for a partial query by referencing a database of the user's contacts.

### SUMMARY

According to one innovative aspect of the subject matter described in this specification, patterns of text (or “display suggestions”) are identified from a text corpus associated with a user, and a particular pattern of text may be displayed to a user as a suggested query completion when one or more characters entered by a user match a term (or “actual suggestion”) that is included as part of the particular pattern of text. For example, when the user enters characters “ex,” which match the suggested query completion (or actual suggestion) “example,” the system may display patterns of text (or display suggestions) from the user's email corpus, such as the email addresses “bob@example.com” or “eileen.jones@example.com” that are discovered in the email corpus, because those email addresses include the term “example,” which is an actual suggestion of the user-entered characters “ex.”

According to another innovative aspect of the subject matter described in this specification, a method includes accessing a resource that includes multiple terms, obtaining one or more prefixes that are derived from the multiple terms and, for each prefix, one or more actual suggestions, wherein each actual suggestion is a term from the resource that includes the prefix, obtaining one or more display suggestions, wherein each display suggestion includes two or more successive terms from the resource that are identified as related, and outputting, in response to receiving a user input of a particular prefix, a representation of a particular display suggestion that includes a term that is an actual suggestion for the particular prefix.

Other embodiments of these aspects include corresponding systems, apparatus, and computer programs, configured to perform the actions of the methods, encoded on computer storage devices.

These and other embodiments may each optionally include one or more of the following features. For instance the resource includes an electronic message; obtaining one or more prefixes that are derived from the multiple terms and, for each prefix, one or more actual suggestions further includes obtaining, for each prefix, data identifying a respective frequency that each of the one or more actual suggestions occur in a set of resources that includes the resource; one or more of the actual suggestions comprises two or more terms; each display suggestion includes two or more successive terms that match a predefined pattern or format; each display suggestion represents an e-mail address; each display suggestion represents a physical address; each display suggestion represents a proper name; each display suggestion represents a uniform resource identifier (URI); the method includes generating, for the particular prefix, an actual suggestion-display suggestion pair that includes the particular suggestion and the term that is the actual suggestion for the particular prefix, and storing data associating the actual suggestion-display suggestion pair with the particular prefix; the method includes assigning a score to the actual suggestion-display suggestion pair based on a frequency that the actual suggestion occurs in a set of resources that includes the resource; the method includes assigning a score to the actual suggestion-display suggestion pair based on a number of times that the particular display suggestion has been output and selected in response to receiving one or more other user inputs of the particular prefix; the method includes assigning a score to the actual suggestion-display suggestion pair based on a number of times that the actual suggestion occurs outside of a portion of the resource that corresponds to the display suggestion; the method includes selecting the actual suggestion-display suggestion pair, from among multiple actual suggestion-display suggestion pairs that include terms that are actual suggestions for the particular prefix, based on a score for the actual suggestion-display suggestion pair; the method includes receiving an additional user input selecting the representation of the particular display suggestion, and submitting a query that identifies the term that is the actual suggestion for the particular prefix; and/or the query does not identify the particular display suggestion.

Advantageous implementations may include one or more of the following features. Suggestions can be derived from a single indexed corpus. Display suggestions can be generated when indexing a document, and the suggestions can be built into the document's lexicon. A single lexicon (e.g., an index's lexicon) can be maintained across multiple documents, and can be shared by all of the documents.

The details of one or more implementations are set forth in the accompanying drawings and the description below. Other potential features and advantages will become apparent from the description, the drawings, and the claims.

### BRIEF DESCRIPTION OF THE DRAWINGS

FIGS. 1 and 2 are diagrams of example systems that can provide display suggestions for term prefixes.

FIG. 3 shows an example data flow for providing display suggestions.

FIG. 4 shows an example user interface for providing display suggestions.

FIG. 5 is a flow chart illustrating an example process for providing display suggestions.

FIG. 6 shows an example of a generic computer device and a generic mobile computer device.

Like reference numbers and designations in the various drawings indicate like elements.

### DETAILED DESCRIPTION

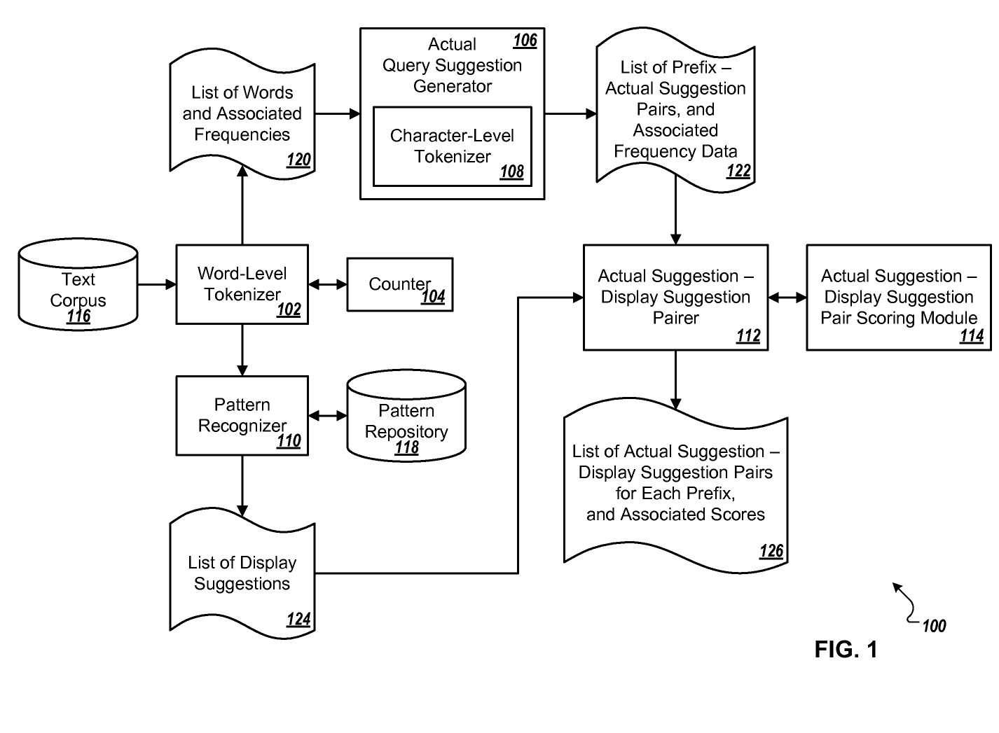

FIG. 1 is a diagram of an example system 100 that can provide display suggestions for term prefixes. In general, based on a term prefix (e.g., a partial query), the system 100 (e.g., a suggestion server) can provide a list of suggestions (e.g., suggested query completions) for the prefix. Considering the characters “ro”, for example, a suggestion algorithm may suggest a list of queries, such as “Robert”, “Rome”, and “royal flush”. The list of suggested queries may be derived from the lexicon of the corpus being searched, and may be ranked according to a likelihood of a user selecting each suggestion.

Some of the suggestions in a list of suggestions may be associated with additional related terms that may be presented to a user as display suggestions, to assist the user in identifying a desired selection. When searching a corpus of e-mail, for example, the user may enter part of a contact's first name (e.g., “ro”), and a suggested query may include the completed name (e.g., “Robert”). However, to help the user disambiguate between multiple contacts with the first name “Robert”, for example, additional related terms may be provided to the user, such as the contact's last name and e-mail address. In the present example, for the prefix “ro”, the display suggestion “Robert Jones (bob@example.com)” and “Robert Smith (robert_smith@example.com)” may be identified for presentation to the user.

An actual suggestion may be paired with a display suggestion. The actual suggestion, for example, may generally be hidden from a user, and may be used by a search algorithm to recall data for the user. If the user selects a display suggestion, for example, the corresponding actual suggestion may be submitted to the search algorithm in its place. In the present example, if the user were to select the display suggestion “Robert Jones (bob@example.com)”, the actual suggestion may include the original suggestion term “Robert”, and may (or may not) include one or more additional terms included in the display suggestion, such as the terms “Jones”, “bob”, “example”, and/or “com”.

In further detail, the system 100 includes various system components, including a word-level tokenizer 102 and an associated counter 104, an actual query suggestion generator 106 including a character-level tokenizer 108, and a pattern recognizer 110. Each of the components 102, 104, 106, 108, and 110, for example, may include one or more hardware and/or software-based modules configured for execution by one or more computer processors. The components 102, 104, 106, 108, and 110, for example, may be executed on a single computing device (e.g., a smartphone, personal digital assistant, tablet computer, laptop or desktop computer, server, or other appropriate stationary or portable device), or the components may be distributed among multiple computing devices and/or servers for execution.

The system 100 includes various data stores, including a text corpus 116 and a pattern repository 118. The data stores 116 and 118, for example, may implement databases, file systems, and other appropriate mechanisms for adding, removing, and maintaining data used by the system 100 for providing display suggestions.

The text corpus 116, for example, may include a set of structured or unstructured text resources, such as e-mails or other sorts of documents. The word-level tokenizer 102, for example, can access each resource included in the text corpus 116, and can parse each resource to identify a set of included words. Using the counter 104, for example, the word-level tokenizer 102 can maintain a count for each word as it is encountered in the resources, and can generate a list 120 of words and associated frequencies. The list 120 can be provided to the actual query suggestion generator 106, for example, which can derive one or more possible prefixes for each word, using the character-level tokenizer 108. Considering the word “example” as an example, the character-level tokenizer 108 can identify the term prefixes “e”, “ex”, “exa”, “exam”, “examp”, “exampl” and the completed term “example”. The actual query suggestion generator 106, for example, can combine the term prefix information with information from the list 120 of words and associated frequencies to generate a list 122 of prefix—actual suggestion pairs, and associated frequency data. In the present example, each of the term prefixes “e”, “ex”, “exa”, etc., may be associated with the actual suggestion “example”, along with the frequency of the term “example” in the text corpus 116.

The word-level tokenizer 102, for example, may also provide information to the pattern recognizer 110. In general, the pattern recognizer 110 may use an entity detector (or another sort of algorithm) for recognizing how terms included in a resource may relate to each other, using natural language processing techniques, statistical inferences of related words, token recognition, and/or pattern matching. For example, the pattern recognizer 110 can reference the pattern repository 118 to determine whether two or more successive terms identified by the word-level tokenizer 102 match a predefined pattern or format. Considering the text string “Robert Jones (bob@example.com)”, for example, the pattern recognizer 110 can recognize the string as representing an e-mail address (e.g., by matching the string to an RFC822 format). Upon recognizing a text string representing an entity (i.e., a person, place, thing, or concept), such as an e-mail address, physical address, proper name, or Uniform Resource Identifier (URI), or another sort of representation, the pattern recognizer 110 can add the text string to a list 124 of display suggestions.

The actual suggestion—display suggestion pairer 112, for example, can match each actual suggestion with one or more display suggestions. For each actual suggestion term included in the list 122 of prefix—actual suggestion pairs, for example, the actual suggestion—display suggestion pairer 112 can determine whether the term occurs in the list 124 of display suggestions. The term “you”, for example, may be identified as an actual suggestion in the list 122, yet may not happen to be included as a component term for any of the display suggestions in the list 124. Thus, the term “you” in the present example may not be paired with a display suggestion. However, the term “example”, for example, may be identified as an actual suggestion in the list 122, and may be included as a component term for multiple display suggestions (e.g., multiple e-mail addresses having the “example” domain) in the list 124. Thus, the term “example” in the present example may be paired with each matching display suggestion (e.g., “Robert Jones (bob@example.com)” and “Robert Smith (robert_smith@example.com)”) by the actual suggestion—display suggestion pairer 112. Each component term (e.g., tokenized word), for example, may be stored in a multimap or another suitable data structure, where the component term may serve as a map key, and a display suggestion may serve as a map value.

The actual suggestion—display suggestion pairer 112 can use the actual suggestion—display suggestion pair scoring module 114, for example, to score or rank actual suggestion—display suggestion pairs. In general, scores may be based on various criteria, including the frequency of an actual suggestion in the text corpus 116, the frequency of a display suggestion in the text corpus 116, the number of times that a display suggestion has been previously selected by a user, and other appropriate criteria. Using information obtained from the list 124 of display suggestions, the list 122 of prefix—actual suggestion pairs, and the actual suggestion—display suggestion pair scoring module 114, for example, the actual suggestion—display suggestion pairer 112 can generate a list 126 of actual suggestion—display suggestion pairs for each prefix, and associated scores. The list 126 and associated scores, for example, can be used to create a merged list of actual suggestions (e.g., for terms with no associated display suggestion) and display suggestions for presentation to a user.

By generating and providing display suggestions in place of actual suggestions, for example, users may be provided with recognizable completions for partially entered search queries. Moreover, by recognizing entities within a text corpus, display suggestions may be derived from the text corpus without external input. For example, e-mail addresses may be identified from a corpus of e-mail messages, without referencing a database of contacts.

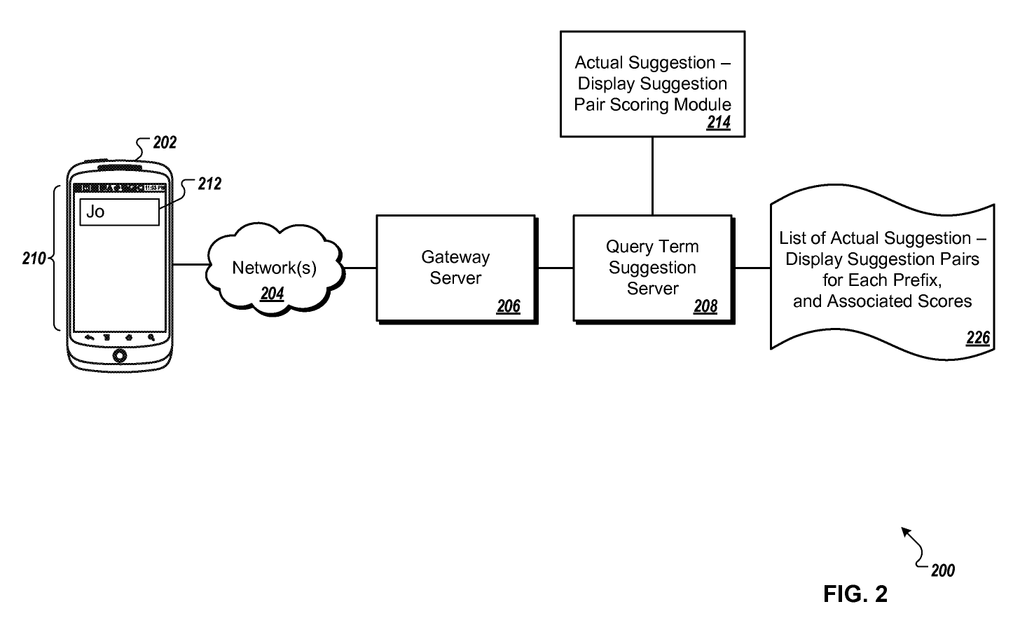

FIG. 2 is a diagram of an example system 200 that can provide display suggestions for term prefixes. In general, based on a received term prefix (e.g., a partial query), the system 200 (e.g., a search suggestion system) can provide a list of suggestions (e.g., suggested query completions) for the term prefix. Further, based on user interaction with the list of suggestions, for example, the system 200 can adjust one or more scores associated with the suggestions, and the adjusted scores can be used to influence the presentation of the suggestions in subsequent lists, in response to subsequently received prefixes.

In further detail, the system 200 includes a mobile computing device 202 (e.g., a smartphone, personal digital assistant, tablet computer, e-book reader, media player, or another appropriate sort of device) which may communicate over one or more networks 204 (e.g., local area networks (LANs), wide area networks (WANs), the Internet, etc.) with a gateway server 206, using wired and/or wireless connections. The gateway server 206, for example, can provide a front-end interface 210 including a control 212 for receiving input from a user of the device 202. Further, the gateway server 206 may communicate with a query term suggestion server 208, which may execute various system components, such as word-level tokenizers and associated counters, actual query suggestion generators, character-level tokenizers, and pattern recognizers, as shown in FIG. 1. The gateway server 206 and the query term suggestion server 208, for example, may exist on a single computing device (e.g., a single client device or server), or may be distributed across multiple computing devices (e.g., blade servers included in a server farm or cloud computing environment).

In some implementations, the system 200 may perform one or more operations in an offline mode. Referring to FIG. 1, for example, one or more (or all) of the components of the system 100 can be maintained and executed by the computing device 202. Thus, search suggestions may be generated and provided locally on the device 202, for example, without data communication via the network(s) 204 and the gateway server 206. As another example, one or more operations of the system 200 may be distributed across multiple devices and/or performed in batch mode. For example, a list 226 of actual suggestion—display suggestion pairs for each prefix (e.g., similar to the list 126 of actual suggestion—display suggestion pairs for each prefix, shown in FIG. 1) can be periodically updated by the query term suggestion server 208 and provided to the device 202 for generating and providing search suggestions locally on the device.

Using the device 202, for example, a user can input (e.g., type) a term prefix, and can receive one or more suggested completions based on the prefix. In the present example, the user types the prefix “Jo” into the control 212 included in the interface 210 (e.g., an e-mail search interface). The device 202, for example, may provide (e.g., using Hypertext Transfer Protocol (HTTP) or another suitable communication protocol) a data representation of the prefix to the gateway server 206 via the network(s) 204, and may provide one or more associated identifiers (e.g., the user's e-mail account identifier). The gateway server 206, for example, can provide the prefix to the query term suggestion server 208.

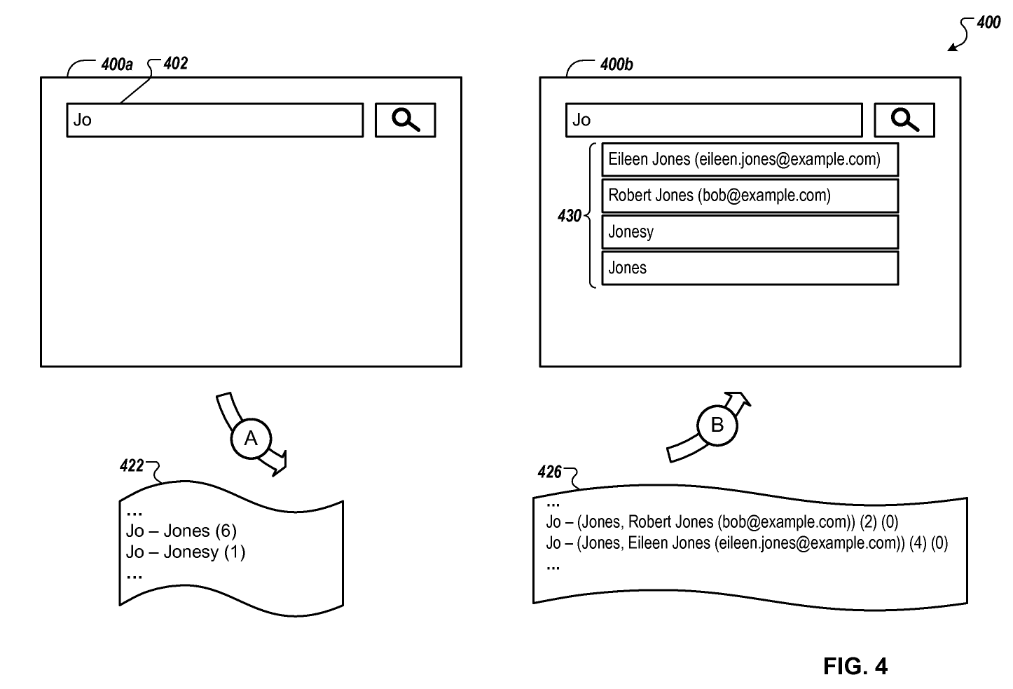

In the present example, upon receiving the term prefix “Jo”, the query term suggestion server 208 can identify one or more suggestions for completed terms from the list 226 of actual suggestion—display suggestion pairs for each prefix. For example, the prefix “Jo” may be mapped to the suggested term “Jones”, which may be mapped to the display suggestions “Robert Jones (bob@example.com)”, and “Eileen Jones (eileen.jones@example.com)”. The display suggestions (and other possible suggested terms which may not have associated display suggestions) may be sorted in a list by the query term suggestion server 208, for example, based on their respective scores. The list of suggestions (shown in FIG. 4) can be provided to the device 202 for presentation to the user, via the gateway server 206 and the network(s) 204.

Upon receiving the list of suggestions, for example, the user of the device 202 may select (e.g., click) a desired suggestion and the device may submit the suggestion to a query server (not shown) as a search query entered by the user, and the user may in turn receive corresponding search results. Further, in the present example, the device 202 may submit the selected suggestion to the query term suggestion server 208 (via the network(s) 204 and the gateway server 206), and the server 208 can use the actual suggestion—display suggestion pair scoring module 214 (e.g., similar to the actual suggestion—display suggestion pair scoring module 114, shown in FIG. 1) to modify a score associated with the selected suggestion. If the user of the device 202 selects the display suggestion “Robert Jones (bob@example.com)”, for example, a score associated with the suggestion may be increased, thus potentially altering the placement of the suggestion in subsequent lists of suggestions which may be provided to the user.

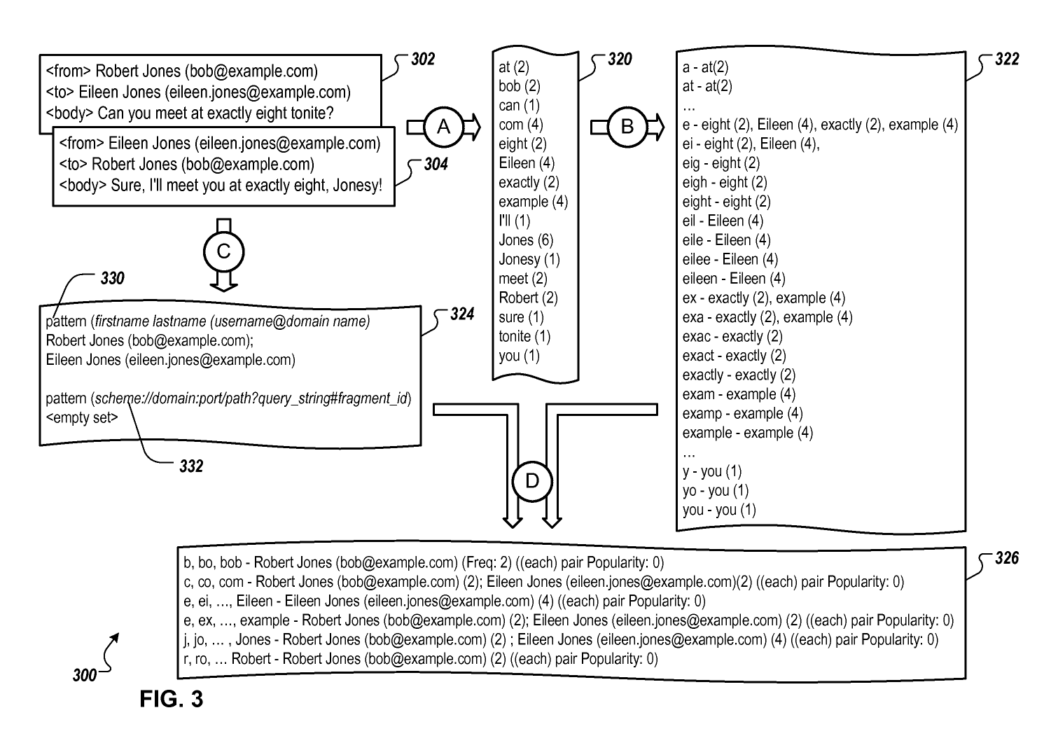

FIG. 3 shows an example data flow 300 for providing display suggestions. In some implementations, the data flow 300 may be performed by the systems 100 and/or 200, and will be described as such for clarity. Briefly, the data flow 300 includes accessing one or more resources (e.g., electronic messages 302 and 304) that include multiple terms, and processing the resources to generate a list 320 of words and associated frequencies, a list 322 of prefix—actual suggestion pairs, a list 324 of display suggestions, and a list 326 of actual suggestion—display suggestion pairs.

In more detail, each of the electronic messages 302 and 304, for example, may be stored in a corpus of e-mails (e.g., the text corpus 116, shown in FIG. 1), and each may include various text blocks and formatting designators. The message 302, for example, is an e-mail message from Robert Jones (bob@example.com) to Eileen Jones (eileen.jones@example.com), with the message text of “Can you meet at exactly eight tonite?” The message 304, for example, is an e-mail reply from Eileen Jones (eileen.jones@example.com) to Robert Jones (bob@example.com), with the message text of “Sure, I'll meet you at exactly eight, Jonesy!”

Referring to the example data flow, during stage (A), the list 320 of words and associated frequencies (e.g., similar to the list 120, shown in FIG. 1) can be generated by the word-level tokenizer 102 and the associated counter 104. Each tokenized word, for example, may be listed in association with its frequency in the messages 302 and 304. In the present example, the “from” and “to” field values, and the message body text of each of the messages 302 and 304 can be analyzed, to generate a list of words included in the messages, and a count of word occurrences: at (2); bob (2); can (1); com (4); eight (2); Eileen (4); exactly (2); example (4); I′ll (1); Jones (6); Jonesy (1); meet (2); Robert (2); sure (1); tonite (1); and you (1). In some implementations, a single resource may be analyzed. For example, a separate list of included words and a separate count of word occurrences can be maintained for each of the messages 302 and 304. In some implementations, counts of word occurrences may be estimated. For example, the word-level tokenizer 102 and associated counter 104 can analyze a subset of resources included in the text corpus 116, and can extrapolate total word counts based on the subset.

During stage (B), the list 322 of prefix—actual suggestion pairs (e.g., similar to the list 122, shown in FIG. 1) can be generated by the actual query suggestion generator 106 and the character-level tokenizer 108. For each word in the list 320 of words and associated frequencies, for example, one or more possible prefixes may be identified, and each prefix may be associated with the frequency of the word. For example, the word “at” occurs twice in the set of messages 302 and 304, and is thus associated with a frequency of two in the list 320 of words and associated frequencies. Referring to the list 322, for example, the prefix “a” of the word “at” can be associated with a frequency of two, and the word completion “at” can also be associated with a frequency of two. As another example, the prefix “e” is identified as being a prefix of multiple words in the list 320 of words and associated frequencies: “eight” (which has a frequency of two), “Eileen” (which has a frequency of four), “exactly” (which has a frequency of two), and “example” (which has a frequency of four). Thus, in the present example, the prefix “e” is mapped to each possible word completion, along with the frequency (count) of each word. The list 322, for example, shows a subset of all of the possible prefix—completion—frequency mappings for the list 320 of words and associated frequencies.

During stage (C), the list 324 of display suggestions (e.g., similar to the list 124, shown in FIG. 1) can be generated by the pattern recognizer 110, based on information received from the word-level tokenizer 102. For example, based on a pattern 330 (e.g., an RFC822 format) obtained from the pattern repository 118, the pattern recognizer 110 can analyze successive terms included in each of the messages 302 and 304 to identify a series of terms that represents an e-mail address. In the present example, the pattern recognizer 110 recognizes the e-mail addresses “Robert Jones (bob@example.com)” and “Eileen Jones (eileen.jones@example.com)”. Based on a pattern 332 (e.g., a URI format), for example, the pattern recognizer 110 may not recognize any corresponding uniform resource identifiers in the set of messages 302 and 304—and may thus return an empty set.

During stage (D), the list 326 of actual suggestion—display suggestion pairs (e.g., similar to the list 126, shown in FIG. 1) can be generated by the actual suggestion—display suggestion pairer 112, based on information maintained by the list 324 of display suggestions, and the list 322 of prefix—actual suggestion pairs. Each tokenized word included in the list 324 of display suggestions, for example, can be matched with its corresponding prefixes in the list 322 of prefix-actual suggestion pairs.

In some implementations, the frequency of which a particular term is associated with a particular display suggestion may be identified and may be associated with the respective display suggestion. For example, the prefixes “j”, “jo”, etc., may each be associated with the term “Jones”—thus, in the present example, the term “Jones” may serve as an actual suggestion for any of the prefixes “j”, “jo”, etc. Referring to the list 320 of words and associated frequencies, for example, the term “Jones” occurs six times in the set of messages 302 and 304. The actual suggestion—display suggestion pairer 112, for example, may determine that two instances of the term “Jones” occur in association with the display suggestion “Robert Jones (bob@example.com)” (i.e., one in the “from” block of message 302 and one in the “to” block of message 304), and that four instances of the term “Jones” occur in association with the display suggestion “Eileen Jones (eileen.jones@example.com)” (i.e., two in the “to” block of message 302 and two in the “from” block of message 304).

In some implementations, a score may be assigned to an actual suggestion—display suggestion pair, based on a number of times that the particular display suggestion has been output and selected by a user in response to receiving user inputs of a particular prefix. For example, a popularity score may be maintained by the actual suggestion—display suggestion pair scoring module 112, for each actual suggestion—display suggestion in the list 326. In the present example, in response to receiving user input of the prefix “jo”, for example, the device 202 may present the display suggestions “Eileen Jones (eileen.jones@example.com)” and “Robert Jones (bob@example.com)” (among other possible suggestions). Initially, the popularity of each display suggestion may be zero, for example. However, if the user happens to select one of the suggestions, its popularity score may be incremented in association with the actual suggestion and/or prefix which triggered its display. Thus, in the present example, the query term suggestion server 208 may be trained to preferentially present (e.g., by modifying list placement, font selection, highlighting, etc.) a particular display suggestion upon receiving a particular prefix from a particular user.

FIG. 4 shows an example user interface 400 for providing display suggestions. In some implementations, the user interface 400 may be presented by the device 202 of the system 200 (shown in FIG. 2), and will be described as such for clarity. Briefly, the user interface 400 may receive user input of a prefix (e.g., a partial query), and may output representations of various suggestions (e.g., query completions), that may in turn be selected by the user.

In more detail, the user interface 400 (shown here as interface 400a) may include a control 402 for receiving user input. During stage (A), for example, a user of the interface 402 may input (e.g., type) the text characters “Jo” into the control 402. As the characters are input, for example, the device 202 can submit the characters to the query term suggestion server 208 via the network(s) and the gateway server 206. The query term suggestion server 208, for example, can reference a list 422 of prefix—actual suggestion pairs (e.g., similar to the list 122, shown in FIG. 1, and the list 322, shown in FIG. 3) to identify one or more completed terms, based on the prefix. In the present example, the prefix “Jo” has been mapped to two terms (i.e., actual suggestions)—“Jones”, which has six occurrences in the user's messages, and “Jonesy”, which has one occurrence.

The query term suggestion server 208, for example, can reference a list 426 of actual suggestion—display suggestion pairs (e.g., similar to the list 126, shown in FIG. 1, the list 226, shown in FIG. 2, and the list 326, shown in FIG. 3) to identify one or more display suggestions, based on the received prefix. In the present example, the prefix “Jo” (a prefix of the actual suggestion “Jones”) has been mapped to the display suggestions “Robert Jones (bob@example.com)” and “Eileen Jones (eileen.jones@example.com)”. As another example, one or more display suggestions may be identified based on identified term completions (e.g., “Jones” and “Jonesy”). In the present example, “Jones” has been mapped to the display suggestions “Robert Jones (bob@example.com)” and “Eileen Jones (eileen.jones@example.com)”, whereas “Jonesy” has not been mapped to any display suggestions.

In some implementations, a score may be assigned to an actual suggestion—display suggestion pair, based on a frequency that the actual suggestion occurs in a set of resources. For example, the actual suggestion—display suggestion pair of “Jones” and “Robert Jones (bob@example.com)” has a frequency score of two, as the display suggestion occurs twice in the set of messages 302 and 304 (shown in FIG. 3), and the actual suggestion occurs once in each display suggestion. The actual suggestion—display suggestion pair of “Jones” and “Eileen Jones (eileen.jones@example.com)”, for example, has a frequency score of four, as the display suggestion occurs twice in the set of messages 302 and 304, and the actual suggestion occurs twice in each display suggestion.

During stage (B), for example, the query term suggestion server 208 can generate a list 430 of suggestions for presentation to the user via the interface 400 (shown here as interface 400b). Each of the candidate suggestions from the list 422 of prefix—actual suggestion pairs, and from the list 426 of actual suggestion—display suggestion pairs, for example, may be ranked by the query term suggestion server 208 and the actual suggestion—display suggestion pair scoring module 214 to influence the ordering of the list 430. In general, frequency and/or popularity scores may be used by the query term suggestion server 208 to approximate the likelihood that a user will select an unpaired actual suggestion or a display suggestion. Terms that frequently occur in a corpus of resources, for example, may generally be searched by a user more often than terms that occur infrequently. Moreover, a display suggestion may occasionally be more popular for searching than one or more of its component terms.

In some implementations, a score may be assigned to an actual suggestion—display suggestion pair based on a number of times that an actual suggestion occurs outside of a portion of a resource that corresponds to a display suggestion. For example, the term “Jones” (an actual suggestion) may appear six times in a corpus of user messages, but may appear relatively infrequently (or never) outside of the context of the display suggestions “Robert Jones (bob@example.com)” and “Eileen Jones (eileen.jones@example.com)”. Thus, in the present example, scores may be increased for the display suggestions “Robert Jones (bob@example.com)” and “Eileen Jones (eileen.jones@example.com)”, and/or a score for the actual suggestion “Jones” may be decreased. For example, the frequency score of the unpaired actual suggestion “Jones” may be decreased, based on the number of times it appears in the context of a display suggestion (e.g., an e-mail address). Since the user may infrequently (or never) use the term “Jones” outside of the context of an e-mail address, for example, preferentially scoring and displaying e-mail addresses that include the term “Jones” may assist the user in recognizing suggested prefix completions, by showing the term in the context of how it may generally be used.

Considering the display suggestions “Robert Jones (bob@example.com)” and “Eileen Jones (eileen.jones@example.com)”, and the unpaired actual suggestion “Jonesy”, for example, the suggestions may be ranked, based at least in part on their respective frequency scores. In the present example, as the display suggestion “Eileen Jones (eileen.jones@example.com)” has a frequency of four, it may be sorted at the top of the list 430, followed by the display suggestion “Robert Jones (bob@example.com)” (e.g., with a frequency of two), and followed by the unpaired actual suggestion “Jonesy” (e.g., with a frequency of one). As has been discussed above, the unpaired actual suggestion “Jones” may have an adjusted frequency score of zero, and may thus be sorted to the bottom of (or removed from) the list 430.

Additional user input may be received, selecting a representation of a particular display suggestion. For example, the user may select (e.g., click) the display suggestion “Robert Jones (bob@example.com)” from the list 430. The selection, for example, may be submitted to a search engine (not shown) for initiation of a query that may identify a term that is an actual suggestion for a particular prefix. In the present example, the actual suggestion “Jones” for the prefix “Jo” may be submitted to the search engine, when the user selects the display suggestion “Robert Jones (bob@example.com)”. In some implementations, an actual suggestion term and one or more additional component terms of a display suggestion may be submitted as a query, upon receiving user input associated with a selection of a particular display suggestion. For example, if the user selects the display suggestion “Robert Jones (bob@example.com)” from the list 430, one or more of the component terms “Robert”, “bob”, “example, and/or “com” may be submitted, in addition to the actual suggestion “Jones”. In general, a submitted query may be different from, or may be similar to a selected display suggestion.

In some implementations, a score may be assigned to an actual suggestion-display suggestion pair, based on a number of times that a particular display suggestion has been output and selected in response to receiving one or more other user inputs of a particular prefix. For example, an indication of the user's selection of the display suggestion “Robert Jones (bob@example.com)” may be submitted to the query term suggestion server 208 and the actual suggestion—display suggestion pair scoring module 214. Upon receiving the indication, for example, the scoring module 214 can adjust (e.g., increase) a popularity score for the display suggestion “Robert Jones (bob@example.com)”.

In some implementations, a popularity score may be adjusted for a display suggestion, irrespective of any of its component terms. For example, a single popularity score may be maintained for the display suggestion “Robert Jones (bob@example.com)”, and the score may be adjusted such that the display suggestion's ranking may be subsequently modified, regardless of which prefix may be used to retrieve it. In some implementations, a separate popularity score may be maintained in association with each component term associated with a display suggestion. For example, the user may generally select the display suggestion “Robert Jones (bob@example.com)” after typing the prefix “Jo” (which maps to “Jones”), but may generally select another selection after typing the prefix “bo” (which maps to “bob”). Thus, in the present example, a different (e.g., higher) popularity score may be used for the display suggestion “Robert Jones (bob@example.com)” when the user types “Jo”, as opposed to when the user types “bo”.

In some implementations, an actual suggestion-display suggestion pair may be selected from among multiple actual suggestion-display suggestion pairs that include terms that are actual suggestions for a particular prefix, based on a score for the actual suggestion-display suggestion pair. For example, upon receiving a subsequent input of the prefix “Jo” from the user, the query term suggestion server 208 may again identify the actual suggestion “Jones” in the list 422 of prefix—actual suggestion pairs, and may again identify the actual suggestion—display suggestion pair of “Jones” and “Robert Jones (bob@example.com)”, and the actual suggestion—display suggestion pair of “Jones” and “Eileen Jones (eileen.jones@example.com)” in the list 426 of actual suggestion—display suggestion pairs. In the present example, the popularity score for the actual suggestion—display suggestion pair of “Jones” and “Robert Jones (bob@example.com)” may have previously been increased (e.g., from a value of zero to a value of one) based on a previous selection, and its frequency score (e.g., a value of two) may remain unaffected by the previous selection. Thus, in the present example, the actual suggestion—display suggestion pair of “Jones” and “Robert Jones (bob@example.com)” may be ranked higher (or lower) than the actual suggestion—display suggestion pair of “Jones” and “Eileen Jones (eileen.jones@example.com)” (e.g., with a frequency score of four, and a popularity score of zero), based on a scoring algorithm executed by the actual suggestion—display suggestion pair scoring module 214. For example, popularity scores may be weighted more heavily than frequency scores, resulting in an increased ranking for actual suggestion—display suggestion pairs that have previously been selected. As another example, frequency scores may be weighted more heavily than popularity scores, resulting in an increased ranking for display suggestions that appear frequently in a text corpus.

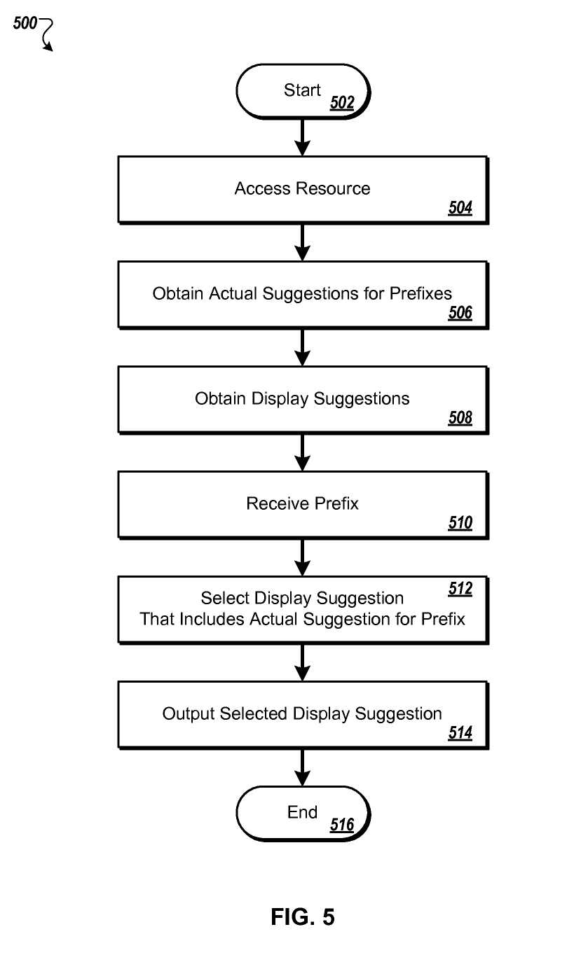

FIG. 5 is a flow chart illustrating an example process 500 for providing display suggestions. In some implementations, the process 500 may be performed by the systems 100 (shown in FIG. 1) and/or 200 (shown in FIG. 2), and will be described as such for clarity. Briefly, the process 500 includes accessing a resource, obtaining actual suggestions for prefixes, obtaining display suggestions, receiving a prefix, selecting a display suggestion that includes an actual suggestion for the prefix, and outputting the selected display suggestion.

In more detail, when the process 500 begins (502), a resource is accessed (504) that includes multiple terms. Referring to FIG. 1, for example, one or more resources maintained by the text corpus 116 may be accessed by the word-level tokenizer 102. Each resource (e.g., e-mail message), for example, may include multiple terms (e.g., words). Referring to FIG. 3, for example, the word-level tokenizer 102 can analyze the electronic messages 302 and 304, and can generate a corresponding list 320 of words and associated frequencies.

One or more prefixes that are derived from the multiple terms are obtained, and for each prefix, one or more actual suggestions are obtained (506). Referring again to FIG. 1, for example, the actual query suggestion generator 106 can use the character-level tokenizer 108 to generate the list 322 of prefix—actual suggestion pairs (shown in FIG. 3). Each actual suggestion may be a term from the resource that includes the prefix. For example, the suggestion “you” is a term from the resource 304 that includes the prefix “y” and “yo”. As another example, the suggestion “Eileen” is a term from each of the resources 302 and 304 that includes the prefixes “e”, “ei”, “eil”, etc.

In some implementations, obtaining one or more prefixes that are derived from the multiple terms may include obtaining, for each prefix, data identifying a respective frequency that each of the one or more actual suggestions occur in a set of resources that includes the resource. Considering the prefix “e” in the present example, the actual suggestions of “eight”, “Eileen”, “exactly”, and “example” occur in the set of resources 302 and 304, with respective frequencies of two, four, two, and four. The respective frequencies, for example, may be stored in the list 322, along with their associated prefix—actual suggestion pairs. In some implementations, one or more of the actual suggestions may include two or more terms. Actual suggestions, for example, may include compound words, phrases, and contractions (e.g., “I'll”).

One or more display suggestions are obtained (508). Referring again to FIG. 1, for example, the pattern recognizer 110 can identify display suggestions, based on terms provided by the word-level tokenizer 102. Each display suggestion may include two or more successive terms of the resource that are identified as related. For example, the pattern recognizer 110 can use an entity detector (or another sort of algorithm) for recognizing how terms included in a resource may be related to each other.

In some implementations, each display suggestion may include two or more successive terms that match a predefined pattern or format. For example, the pattern recognizer 110 can reference the pattern repository 118 to analyze successive terms identified by the word-level tokenizer 102. A display suggestion may represent an e-mail address. For example, the pattern recognizer 110 can determine whether successive terms follow an RFC822 format. A display suggestion may represent a physical address. For example, the pattern recognizer 110 can determine whether successive terms include particular key terms, such as “street”, “avenue”, “drive”, etc., whether the successive terms include numbers, and/or whether the successive terms include the names of known cities, states, or countries. Each display suggestion may represent a proper name. For example, the pattern recognizer 110 can determine whether successive terms include familiar names and/or follow particular capitalization patterns. Each display suggestion may represent a Uniform Resource Identifier (URI). For example, the pattern recognizer 110 can determine whether successive terms follow a URI format. Various possible patterns have been described, however, more or fewer types of patterns may be applied in different implementations.

In some implementations, for a particular prefix, an actual suggestion-display suggestion pair may be generated that includes a particular suggestion and a term that is an actual suggestion for the particular prefix. Referring again to FIG. 3, for example, the list 326 of actual suggestion—display suggestion pairs includes an entry for the prefix “ei”, the actual suggestion “Eileen”, and the display suggestion “Eileen Jones (eileen.jones@example.com)”. Data associating the actual suggestion-display suggestion pair with the particular prefix may be stored, for example, in a database, in a file, in memory, or in another suitable data storage mechanism.

A prefix is received (510). Referring to FIG. 2, for example, user input of the prefix “Jo” may be received via the control 212 included in the interface 210 presented by the device 202. A display suggestion is selected (512) that includes an actual suggestion for the prefix. For example, the query term suggestion server 208 may select a display suggestion that includes an actual suggestion for the prefix “Jo”, from the list 226 of actual suggestion—display suggestion pairs.

The selected display suggestion is output (514), thus ending (516) the process. Referring to FIG. 4, for example, the display suggestion “Robert Jones (bob@example.com)” (potentially among other display suggestions and/or unpaired actual suggestions) can be output to the user as an item in the list 430 of suggestions. The output display suggestion may be a representation of a particular display suggestion that includes a term that is the actual suggestion for the prefix. For example, the display suggestion “Robert Jones (bob@example.com)” may include the term “Jones” that is the actual suggestion for the prefix “Jo”.

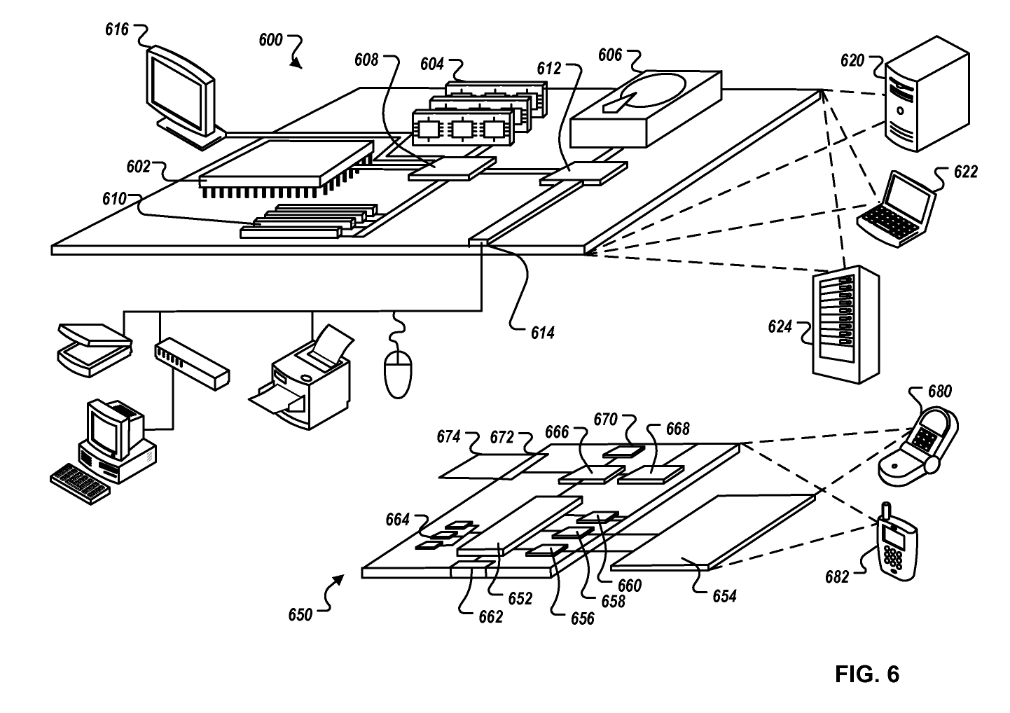

FIG. 6 shows an example of a generic computer device 600 and a generic mobile computer device 650, which may be used with the techniques described herein. Computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smartphones, and other similar computing devices. The components shown here, their connections and relationships, and their functions, are meant to be examples, and are not meant to limit implementations of the inventions described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and may be mounted on a common motherboard or in other manners as appropriate. The processor 602 may process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a volatile memory unit or units. In another implementation, the memory 604 is a non-volatile memory unit or units. The memory 604 may also be another form of computer-readable medium, such as a magnetic or optical disk.

The storage device 606 is capable of providing mass storage for the computing device 600. In one implementation, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. A computer program product may be tangibly embodied in an information carrier. The computer program product may also contain instructions that, when executed, perform one or more methods, such as those described above. The information carrier is a computer- or machine-readable medium, such as the memory 604, the storage device 606, memory on processor 602, or a propagated signal.

The high speed controller 608 manages bandwidth-intensive operations for the computing device 600, while the low speed controller 612 manages lower bandwidth-intensive operations, for example. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 may execute instructions within the computing device 650, including instructions stored in the memory 664. The processor may be implemented as a chipset of chips that include separate and multiple analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT LCD (Thin-Film-Transistor Liquid Crystal Display) or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provide in communication with processor 652, so as to enable near area communication of device 650 with other devices. External interface 662 may provide, for example, for wired communication in some implementations, or for wireless communication in other implementations, and multiple interfaces may also be used.

The memory 664 stores information within the computing device 650. The memory 664 may be implemented as one or more of a computer-readable medium or media, a volatile memory unit or units, or a non-volatile memory unit or units. Expansion memory 674 may also be provided and connected to device 650 through expansion interface 672, which may include, for example, a SIMM (Single In Line Memory Module) card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provide as a security module for device 650, and may be programmed with instructions that permit secure use of device 650. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, memory on processor 652, or a propagated signal that may be received, for example, over transceiver 668 or external interface 662.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS (Global Positioning System) receiver module 670 may provide additional navigation- and location-related wireless data to device 650, which may be used as appropriate by applications running on device 650.

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smartphone 682, personal digital assistant, or other similar mobile device.

Various implementations of the systems and techniques described here may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The systems and techniques described here may be implemented in a computing system that includes a back end component (e.g., as a data server), or that includes a middleware component (e.g., an application server), or that includes a front end component (e.g., a client computer having a graphical user interface or a Web browser through which a user may interact with an implementation of the systems and techniques described here), or any combination of such back end, middleware, or front end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A computer-implemented method comprising:
accessing a resource that includes multiple terms;
obtaining one or more prefixes that are derived from the multiple terms and, for each prefix, one or more actual suggestions, wherein each actual suggestion is a term from the resource that includes the prefix;
obtaining one or more display suggestions, wherein each display suggestion includes two or more successive terms from the resource that are identified as related; and
outputting, in response to receiving a user input of a particular prefix, a representation of a particular display suggestion that includes a term that is an actual suggestion for the particular prefix.

2. The method of claim 1, wherein the resource includes an electronic message.

3. The method of claim 1, wherein obtaining one or more prefixes that are derived from the multiple terms and, for each prefix, one or more actual suggestions further comprises obtaining, for each prefix, data identifying a respective frequency that each of the one or more actual suggestions occur in a set of resources that includes the resource.

4. The method of claim 1, wherein one or more of the actual suggestions comprises two or more terms.

5. The method of claim 1, wherein each display suggestion includes two or more successive terms that match a predefined pattern or format.

6. The method of claim 1, wherein each display suggestion represents an e-mail address.

7. The method of claim 1, wherein each display suggestion represents a physical address.

8. The method of claim 1, wherein each display suggestion represents a proper name.

9. The method of claim 1, wherein each display suggestion represents a uniform resource identifier (URI).

10. The method of claim 1, comprising:
generating, for the particular prefix, an actual suggestion-display suggestion pair that includes the particular suggestion and the term that is the actual suggestion for the particular prefix; and
storing data associating the actual suggestion-display suggestion pair with the particular prefix.

11. The method of claim 10, comprising:
assigning a score to the actual suggestion-display suggestion pair based on a frequency that the actual suggestion occurs in a set of resources that includes the resource.

12. The method of claim 10, comprising:
assigning a score to the actual suggestion-display suggestion pair based on a number of times that the particular display suggestion has been output and selected in response to receiving one or more other user inputs of the particular prefix.

13. The method of claim 10, comprising:
assigning a score to the actual suggestion-display suggestion pair based on a number of times that the actual suggestion occurs outside of a portion of the resource that corresponds to the display suggestion.

14. The method of claim 10, comprising:
selecting the actual suggestion-display suggestion pair, from among multiple actual suggestion-display suggestion pairs that include terms that are actual suggestions for the particular prefix, based on a score for the actual suggestion-display suggestion pair.

15. The method of claim 10, comprising:
receiving an additional user input selecting the representation of the particular display suggestion; and
submitting a query that identifies the term that is the actual suggestion for the particular prefix.

16. The method of claim 14, wherein the query does not identify the particular display suggestion.

17. A system comprising:
one or more computers and one or more storage devices storing instructions that are operable, when executed by the one or more computers, to cause the one or more computers to perform operations comprising:
accessing a resource that includes multiple terms;
obtaining one or more prefixes that are derived from the multiple terms and, for each prefix, one or more actual suggestions, wherein each actual suggestion is a term from the resource that includes the prefix;
obtaining one or more display suggestions, wherein each display suggestion includes two or more successive terms from the resource that are identified as related; and
outputting, in response to receiving a user input of a particular prefix, a representation of a particular display suggestion that includes a term that is an actual suggestion for the particular prefix.

18. A computer-readable storage device storing software comprising instructions executable by one or more computers which, upon such execution, cause the one or more computers to perform operations comprising:
accessing a resource that includes multiple terms;
obtaining one or more prefixes that are derived from the multiple terms and, for each prefix, one or more actual suggestions, wherein each actual suggestion is a term from the resource that includes the prefix;
obtaining one or more display suggestions, wherein each display suggestion includes two or more successive terms from the resource that are identified as related; and
outputting, in response to receiving a user input of a particular prefix, a representation of a particular display suggestion that includes a term that is an actual suggestion for the particular prefix.
